(19) United States
(12) Patent Application Publication
(10) Pub. No.: US 2002/0021293 A1
(43) Pub. Date: Feb. 21, 2002

(54) Circuit, driver circuit, electro-optical device, organic electroluminescent display device electronic apparatus, method of controlling the current supply to a current driven element, and method for driving a circuit

(75) Inventor: Simon Tam, Cambridge (GB)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 09/899,916

(22) Filed: Jul. 9, 2001

(30) Foreign Application Priority Data
Jul. 7, 2000 (GB) 0016815.3

(51) Int. Cl. G09G 5/00

(52) U.S. Cl. 345/204

(57) ABSTRACT

A driver circuit comprises a p-channel transistor and an n-channel transistor connected as a complementary pair of transistors to provide analog control of the drive current for a current driven clement, preferably an organic electroluminescent element (OEL element). The transistors, being of opposite channel, compensate, for any variation in threshold voltage ΔV_{T} and therefore provide a drive current to the OEL element which is relatively independent of ΔV_{T}. The complementary pair of transistors can be applied to either voltage driving or current driving pixel driver circuits.

The present invention relates to a driver circuit. One particular application of such a driver circuit is for driving an organic electroluminescent element,

An organic electroluminescent (OEL) element OEL elementcomprises a light emitting material layer sandwiched between an anode layer and a cathode* layer. Electrically, this element operates like a diode. Optically, it emits light when forward biased and the intensity of the emission increases with the forward bias current, It is possible to construct a display panel with a matrix of OEL elements fabricated on a transparent substrate and with at least one of the electrode layers being transparent. It is also possible to integrate the driving circuit on the same panel by using low temperature polysilicon thin film transistor technology.

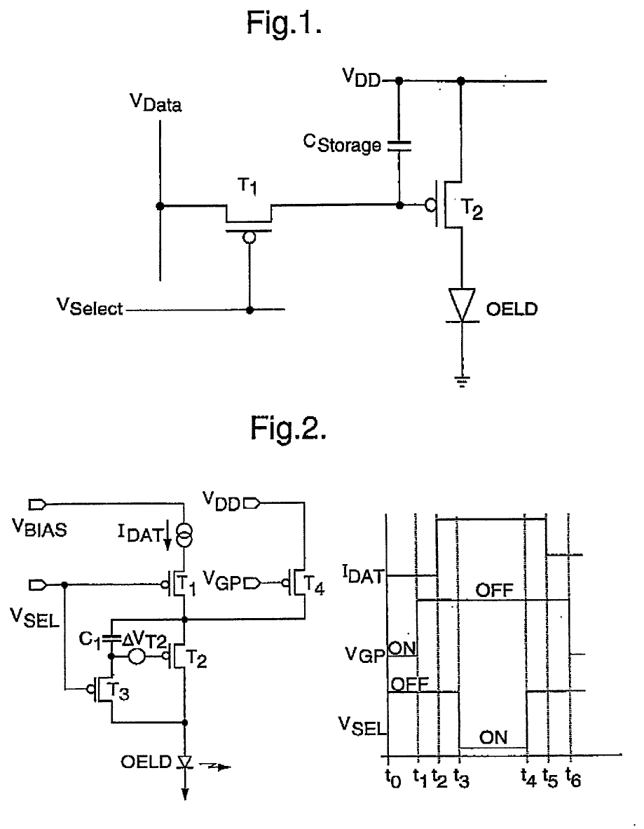

In a basic analog driving scheme for an active matrix OEL display, a minimum of two transistors are required per pixel. Such a driving scheme is illustrated in FIG. 1. Transistor T₁ is provided to address the pixel and transistor T₂ is provided to convert a data voltage signal V_{Data} into current which drives the OEL element at a designated brightness. The data signal is stored by a storage capacitor C_{storage} when the pixel is not addressed. Although p-channel TFTs are shown in the figure, the same principle can also be applied for a circuit utilising-channel TFTs.

There are problems associated with TFT analog circuit and OEL elements do not act like perfect diodes. The light emitting material does, however, have relatively uniform characteristics. Due to the nature of the TFT fabrication technique, spatial variation of the TFT characteristics exists over the extent of the display panel. One of the most important considerations in a TFT analog circuit is the variation of threshold voltage, ΔV_{T}, from device to device. The effect of such variation in an OEL display, exacerbated by the non perfect diode behaviour, is the non-uniform pixel brightness over the display area of the panel, which seriously affects the image quality. Therefore, a built-in circuit for compensating a dispersion of transistor characteristics is required.

A circuit shown in FIG. 2 is proposed as one of built-in for compensating a variation of transistor characteristics. In this circuit, transistor T₁ is provided for addressing the pixel. Transistor T₂ operates as an analog current control to provide the driving current to the OEL element. Transistor T₃ connects between the drain and gate of transistor T₂ and toggles transistor T₂ to act either as a diode or in a saturation mode. Transistor T₄ acts as a switch in response to an applied waveform V_{GP}. Either Transistor T₁ or transistor T₄ can be ON at any one time. Initially, at time t₀ shown in the timing diagram of FIG. 2, transistors T₁ and T₃ are OFF, and transistor T₄ is ON. When transistor T₄ is OFF, transistors T₁ and T₃ are ON, and a current I_{DAT} of known value is allowed to flow into the OEL element, through transistor T₂. This is the programming stage because the threshold voltage of transistor T₂ is measured with transistor T₃ turned ON which shorts the drain and gate of transistor T₂. Hence transistor T₂ operates as a diode while the programming current is allowed to flow through transistors T₁ and T₂ and into the OEL element. The detected threshold voltage of transistor T₂ is stored by a capacitor C₁ connected between the gate and source terns of transistor T₂ when transistors T₃ and T₁ are switched OFF. Transistor T₄ is then turned ON by driving waveform V_{GP} and the current through the OEL element is now provided by supply V_{DD}. If the slope of the output characteristics for transistor T₂ were flat, the reproduced current would be the same as the programmed current for any threshold voltage of T₂ detected and stored in capacitor C₁. However, by turning ON transistor T₄, the drain-source voltage of transistor T₂ is pulled up, so a flat output characteristic will maintain the reproduced current at the same level as the programmed current. Note that ΔV_{T2} shown in FIG. 2 is imaginary, not real. It has been used solely to represent the threshold voltage of transistor T₂.

A constant current is provided, in theory, during a subsequent active programming stage, which is signified by the time interval t₂ to t₅ in the timing diagram shown in FIG. 2. The reproduction stage starts at time t₆.

The circuit of FIG. 2 does provide an improvement over the circuit shown in FIG. 1 but variations in the threshold value of the control transistor are not fully compensated and variations in image brightness over the display area of the panel remain.

The present invention seeks to provide an improved driver circuit. In its application to OEL elements the present invention seeks to provide an improved pixel driver circuit in which variations in the threshold voltages of the pixel driver transistor can be further compensated, thereby providing a more uniform pixel brightness over the display area of the panel and, therefore, improved image quality.

According to a first aspect of the present invention there is provided a driver circuit for a current driven element, the circuit comprising an a-channel transistor and a complementary p-channel transistor connected so as to operatively control, in combination, the current supplied to the current driven element.

Beneficially, the current driven element is an electroluminescent element.

Preferably, the driver circuit also comprises respective storage capacitors for the n-channel and p-channel transistors and respective switching means connected so as to establish when operative respective paths to the n-channel and p-channel transistors for respective data voltage pulses.

Advantageously, the driver circuit may also comprise respective storage capacitors for storing a respective operating voltage of the n-channel and the p-channel transistors during a programming stage, a first switching means connected so as to establish when operative a first current path from a source of current data signals through the n-channel and p-channel transistors and the current driven element during the programming stage, and a second switching means connected to establish when operative a second current path through the n-channel and p-channel transistors and the current driven element during a reproduction stage.

In a further embodiment, the first switching means and the source of current data signals are connected so as to provide when operative a current source for the current driven element.

In an alternative embodiment, the first switching means the source of current data signals are connected so as to provide when operative a current sink for the current driven element.

According to a second aspect of the present invention there is also provided a method of controlling the supply current to a current driven element comprising providing an n-channel transistor and a p-channel transistor connected so as to operatively control, in combination, the supply current to the current driven element.

Preferably, the method further comprises providing respective storage capacitors for the n-channel and p-channel transistors and respective switching means connected so as to establish when operative respective paths to the n-channel and p-channel transistors for respective data voltage pulses thereby to establish, when operative, a voltage driver circuit for the current driven element.

Advantageously, the method may comprise providing a programing stage during which the n-channel and p-channel transistors are operated in a first mode and wherein a current path from a source of current data signals is established through the n-channel and the p-channel transistors and the current driven element and wherein a respective operating voltage of the n-channel transistor and the p-channel transistor is stored in respective storage capacitors, and a reproduction stage wherein a second mode and a second current path is established though the n-channel transistor and the p-channel transistor and the current driven element.

Beneficially, the present invention provides a method of controlling the supply current to an electroluminescent display comprising the method of the invention as described above wherein the current driven element is an electroluminescent element.

According to a third aspect of the present invention, there is also provided an organic electroluminescent display device comprising a driver circuit as claimed in any one of claims 1 to 12.

The present invention will now be described by way of further example only and with reference to the accompanying drawings in which:

FIG. 1 shows a conventional OEL element pixel driver circuit using two transistors;

FIG. 2 shows a known current programmed OEL element driver circuit with threshold voltage compensation;

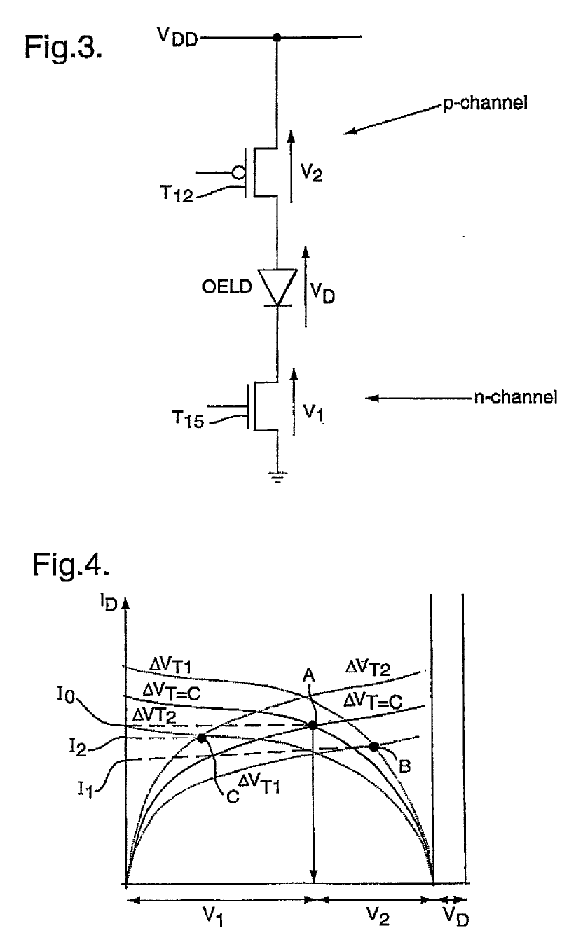

FIG. 3 illustrates the concept of a driver circuit including a complementary pair of driver transistors for providing threshold voltage compensation in accordance with the present invention;

FIG. 4 shows plots of characteristics for the complementary driver transistors illustrated in FIG. 3 for various levels of threshold voltages;

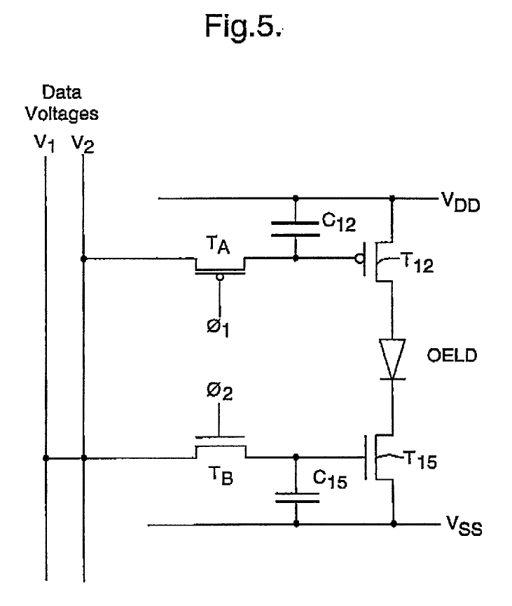

FIG. 5 shows a driver circuit arranged to operate as a voltage driver circuit in accordance with a first embodiment of the present invention.

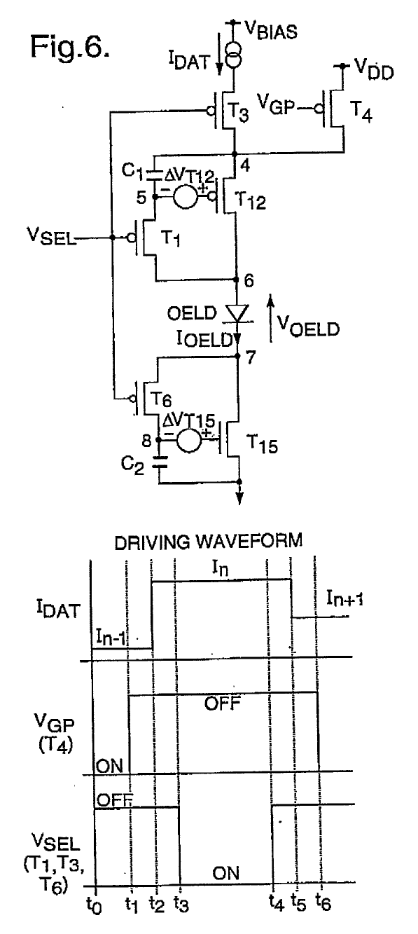

FIG. 6 shows a driver circuit arranged to operate as a current programmed driver circuit in accordance with a second embodiment of the present invention;

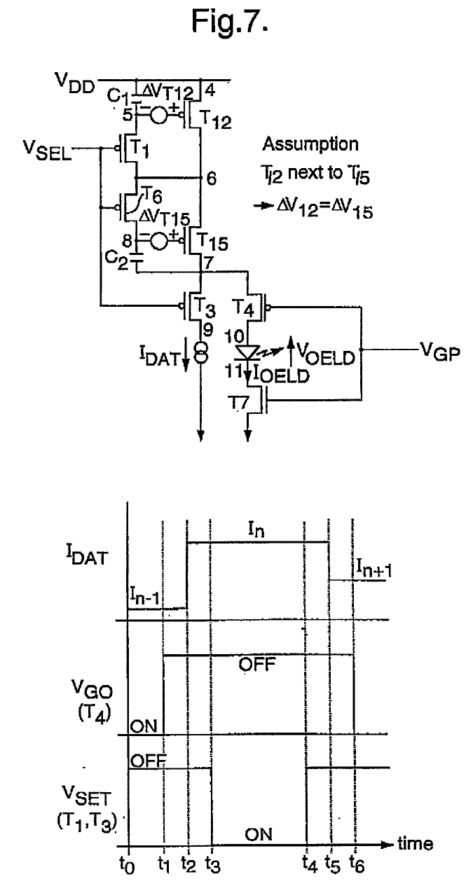

FIG. 7 shows a current programmed driver circuit in accordance with a third embodiment of the present invention;

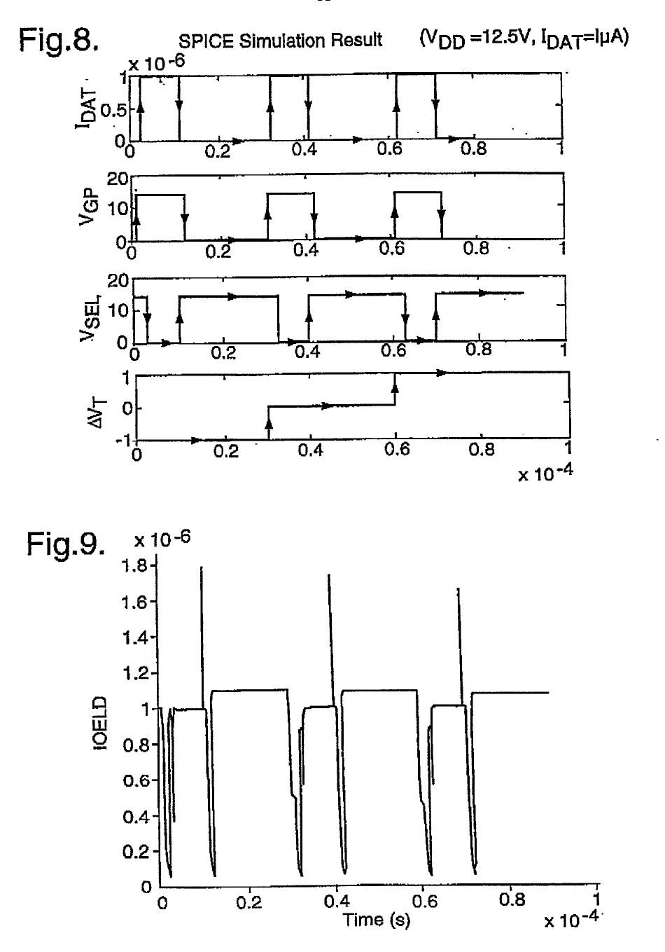

FIGS. 8 to 11 show SPICE simulation results for the circuit illustrated in FIG. 6;

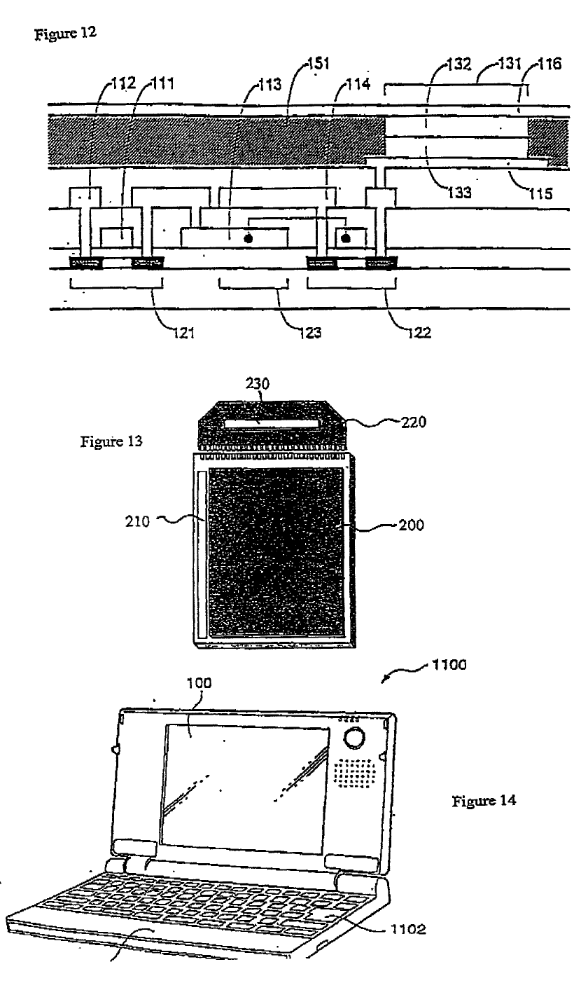

FIG. 12 is a schematic sectional view of a physical implementation of an OEL element and driver according to an embodiment of the present invention;

FIG. 13 is a simplified plan view of an OEL element OEL display panel incorporating the present invention;

FIG. 14 is a schematic view of a mobile personal computer incorporating a display device having a driver according to the present invention;

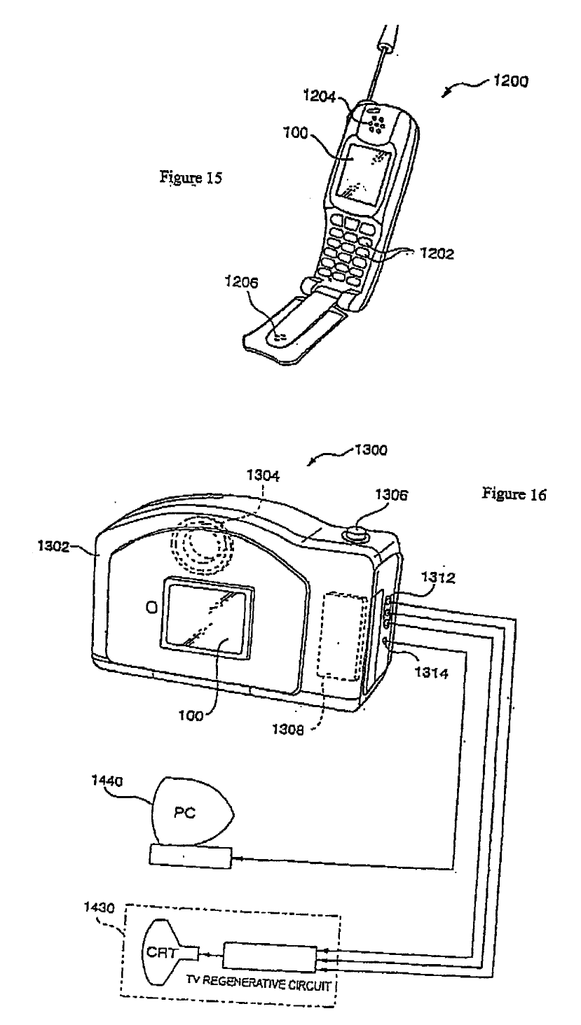

FIG. 15 is a schematic view of a mobile telephone incorporating a display device having a driver according to the present inventor,

FIG. 16 is a schematic view of a digital camera incorporating a display device having a driver according to the present invention,

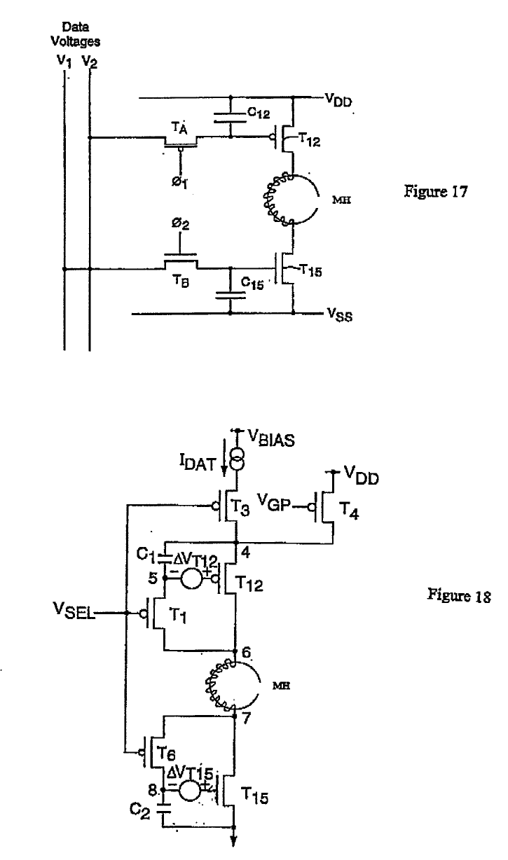

FIG. 17 illustrates the application of the driver circuit of the present invention to a magnetic RAM, and

FIG. 18 illustrates an alternative application of the driver circuit of the present invention to a magnetic RAM, and

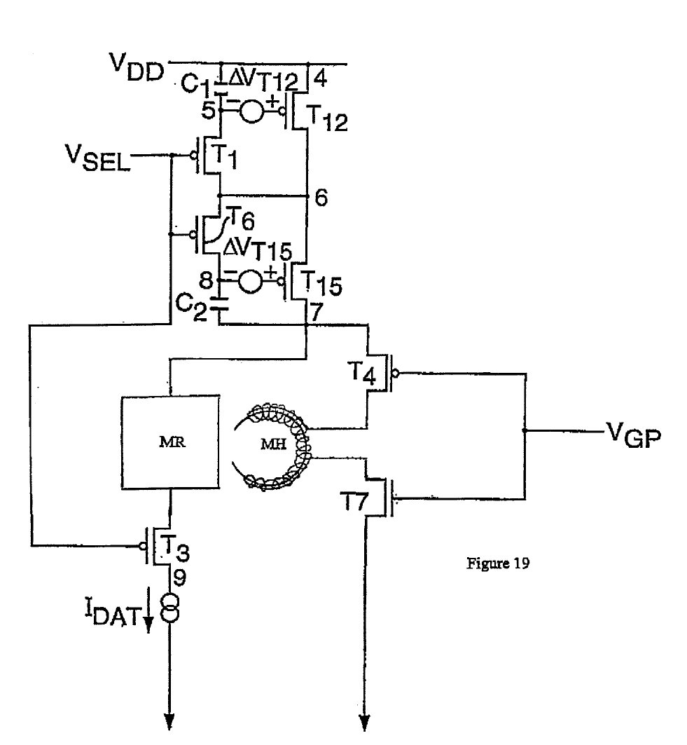

FIG. 19 illustrates the application of the driver circuit of the present Invention to a magnetoresistive element

The concept of a driver circuit according to the present invention is illustrated in FIG. 3. An OEL element is coupled between two transistors T₁₂ and T₁₅ which operate, in combination, as an analog current control for the current flowing through the OEL element. Transistor T₁₂ is a p-channel transistor and transistor T₁₅ is an n-channel transistor which act therefore, in combination, as a complementary pair for analog control of the current through the OEL element.

As mentioned previously, one of the most important parameters in a TFT analog circuit design is the threshold voltage V_{T}. Any variation, ΔV_{T} within a circuit has a significant effect on the overall circuit performance. Variations in the threshold voltage can be viewed as a rigid horizontal shift of the source to drain current versus the gate to source voltage characteristic for the transistor concerned and are caused by the interface charge at the gate of the transistor.

It has been realised with the present invention that in an array of TFT devices, in view of the fabrication techniques employed, neighbouring or relatively close TFT's have a high probability of exhibiting the same or an almost similar value of threshold voltage ΔV_{T}. Furthermore, it has been realised that as the effects of the same ΔV_{T} on p-channel and n-channel TFT's are complementary, compensation for variations in threshold voltage ΔV_{T} can be achieved by employing a pair of TFT's, one channel In and one n-channel TFT, to provide analog control of the driving current flowing to the OEL element. The driving current can, therefore, be provided independently of any variation of the threshold voltage. Such a concept is illustrated in FIG. 3.

FIG. 4 illustrates the variation in drain current, that is the current flowing through the OEL element shown in FIG. 3, for various levels of threshold voltage ΔV_{T}, ΔV_{T1}, ΔV_{T2} for the transistors T₁₂ and T₁₅. Voltages V₁, V₂ and V_{D} are respectively the voltages appearing across transistor T₁₂, T₁₅ and the OEL element from a voltage source V_{DD}. Assuming that the transistors T₁₂ and T₁₅ have the same threshold voltage and assuming that ΔV_{T}=O, then the current flowing through the OEL element,is given by cross-over point A for the characteristics for the p-channel transistor T₁₂ and the n-channel transistor T₁₅ shown in FIG. 4. This is shown by value I₀.

Assuming now that the threshold voltage of the p-channel and n-channel transistors changes to ΔV_{T1}, the OEL element current I₁ is then determined by crossover point B. Likewise, for a variation in threshold voltage to ΔV₂, the OEL element current I₂ is given by crossover point C. It can be seen from FIG. 4 that even with the variations in the threshold voltage there is minimal variation in the current flowing through the OEL element.

FIG. 5 shows a pixel driver circuit configured as a voltage driver circuit. The circuit comprises p-channel transistor T₁₂ and n-channel transistor T₁₅ acting as a complementary pair to provide, in combination, an analog current control for the OEL element. The circuit includes respective storage capacitors C₁₂ and C₁₅ and respectively switching transistors T_{A} and T_{B} coupled to the gates of transistors T₁₂ and T₁₅. When transistors T_{A} and T_{B} are switched ON data voltage signals V₁ and V₂ are stored respectively in storage capacitors C₁₂ and C₁₅ when the pixel is not addressed The transistors T_{A} and T_{B} function as pass gates under the selective control of addressing signals φ₁ and φ₂ applied to the gates of transistors T_{A} and T_{B}.

FIG. 6 shows a driver circuit according to the present invention configured as a current programmed OEL element driver circuit. As with the voltage driver circuit, p-channel transistor T₁₂ and n-channel transistor T₁₅ are coupled so as to function as an analog current control for the OEL element. Respective storage capacitors C₁, C₂ and respective switching transistors T₁ and T₆ are provided for transistors T₁₂ and T₁₅. The driving waveforms for the circuit are also shown in FIG. 6. Either transistors T₁, T₃ and T₆, or transistor T₄ can be ON at any one time. Transistors T₁ and T₆ connect respectively between the drain and gate of transistors T₁₂ and T₁₅ and switch in response to applied waveform V_{SEL} to toggle transistors T₁₂ and T₁₅ to act either as diodes or as transistors in saturation mode. Transistor T₃ is also connected to receive waveform V_{SEL}. Transistors T₁ and T₆ are both p-channel transistors to ensure that the signals fed through these transistors are at the same magnitude. This is to ensure that any spike currents through the OEL element during transitions of the waveform V_{SEL} are kept to a minimum.

The circuit shown in FIG. 6 operates in a similar manner to known current programmed pixel driver circuits in that a programming stage and a display stage are provided in each display period but with the added benefit that the drive current to the OEL element is controlled by the complementary opposite channel transistors T₁₂ and T₁₅. Referring to the driving waveforms shown in FIG. 6, a display period for the driver circuit extends from time t₀ to time t₆. Initially, transistor T₄ is ON and transistors T₁, T₃ and T₆ are OFF. Transistor T₄ is turned OFF at time t₁ by me waveform V_{GP} and transistors T₁, T₃ and T₆ are turned ON at time t₃ by the waveform V_{SEL}. With transistor T₁ and T₆ turned ON, the p-channel transistor T₁₂ and the complementary n-channel transistor T₁₅ act in a first mode as diodes. The driving waveform for the frame period conned is available from the current source I_{DAT} at time t₂ and this is passed by the transistor T₃ when it switches on at time t₃. The detected threshold voltages of transistors T₁₂ and T₁₅ are stored in capacitors C₁ and C₂. These are shown as voltage sources ΔV_{T12} and ΔV_{T15} in FIG. 6.

Transistors T₁, T₃ and T₆ are then switched OFF at time t₄ and transistor T₄ is switched ON at time t₅ and the current through the OEL element is then provided from the source VDD under the control of the p-channel and n-channel transistors T₁₂ and T₁₅ operating in a second mode, i.e. as transistors in saturation mode. It will be appreciated that as the current through the OEL element is controlled by the complementary p-channel and n-channel transistors T₁₂ and T₁₅ any variation in threshold voltage in one of the transistors will be compensated by the other opposite channel transistor, as described previously with respect to FIG. 4.

In the current programmed driver circuit shown m FIG. 6, the switching transistor T₃ is coupled to the p-channel transistor T₁₂, with the source of the driving waveform I_{DAT} operating as a current source. However, the switching transistor T₃ may as an alternative be coupled to the n-channel transistor T₁₅ as shown in FIG. 7, whereby I_{DAT} operates as a current sink. In all other respects the operation of the circuit shown in FIG. 7 is the same as for the circuit shown in FIG. 6.

FIGS. 8 to 11 show a SPICE simulation of an improved pixel driver circuit according to the present invention.

Referring to FIG. 8, this shows the driving waveforms I_{DAT}, V_{GP}, V_{SEL} and three values of threshold voltage, namely −1volt, 0volts and +1volt used for the purposes of simulation to show the compensating effect provided by the combination of the p-channel and n-channel transistors for controlling the current through the OEL element. From FIG. 8, it can be seen that, initially the threshold voltage ΔV_{T} was set at −1volt, increasing to 0volts at 0.3×10⁻⁴ seconds and increasing again to +1volt at 0.6×10⁻⁴ seconds. However, it can be seen from FIG. 9 that even with such variations in the threshold voltage the driving current through the OEL element remains relatively unchanged.

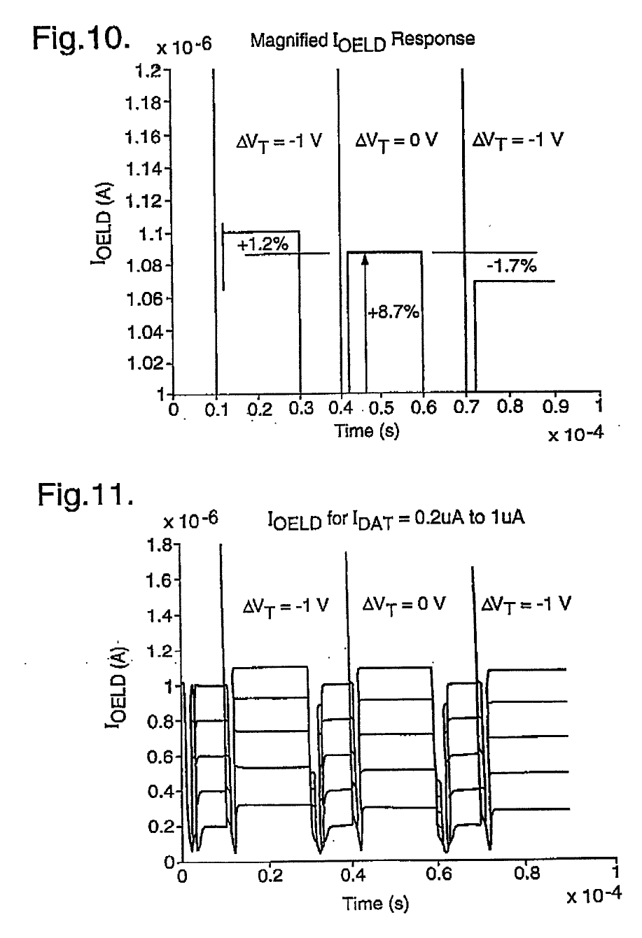

The relative stability in the driving current through the OEL element can be more clearly seen in FIG. 10, which shows a magnified version of the response plots shown in FIG. 9.

It can be seen from FIG. 10 that, using a value of 0 volts as a base for the threshold voltage ΔV_{T}, that if the threshold voltage ΔV_{T} changes to −1volts there is a change of approximately 1.2% in the drive current through the OEL element and if the threshold voltage ΔV_{T} is changed to +1volt, there is a reduction in drive current of approximately 1.7% compared to the drive current when the threshold voltage ΔV_{T} is 0 volts. The variation of drive current of 8.7% is shown for reference purposes only as such a variation can be compensated by gamma correction, which is well known in this art and will not therefore be described in relation to the present invention.

FIG. 11 shows that for levels of I_{DAT} ranging from 0.2 μA to 1.0 μA, the improved control of the OEL element drive current is maintained by the use of the p-channel and opposite n-channel transistors in accordance with the present invention.

It will be appreciated from the above description that the use of a p-channel transistor and an opposite n-channel transistor to provide, in combination, analog control of the drive current through an electroluminescent device provides improved compensation for the effects which would otherwise occur with variations in the threshold voltage of a single p-channel or n-channel transistor.

Preferably, the TFT n-channel and p-channel transistors are fabricated as neighbouring or adjacent transistors during the fabrication of an OEL element OEL display so as to maximise the probability of the complementary p-channel and n-channel transistors having the same value of threshold voltage ΔV_{T}. The p-channel and n-channel transistors may be further matched by comparison of their output characteristics.

FIG. 12 is a schematic cross-sectional view of the physical implementation of the pixel driver circuit in an OEL element structure. In FIG. 12, numeral 132 indicates a hole injection layer, numeral 133 indicates an organic EL layer, and numeral 151 indicates a resist or separating structure. The switching thin film transistor 121 and the n-channel type current thin film transistor 122 adopt the structure and the process ordinarily used for a low-temperature polysilicon thin-film transistor, such as are used for example in known thin-film transistor liquid crystal display devices such as a top-gate structure and a fabrication process wherein the maximum temperature is 600° C. or less. However, other structures and processes are applicable.

The forward oriented organic EL display element 131 is formed by: the pixel electrode 115 formed of Al, the opposite electrode 116 formed of ITO, the hole injection layer 132, and the organic EL layer 133. In the forward oriented organic EL display element 131, the direction of current of the organic EL display device can be set from the opposite electrode 116 formed of ITO to the pixel electrode 115 formed of Al.

The hole injection layer 132 and the organic EL layer 133 maybe formed using an ink-jet printing method, employing the resist 151 as a separating structure between the pixels. The opposite electrode 116 formed of ITO may be formed using a sputtering method. However, other methods may also be used for forming all of these components.

The typical layout of a full display panel employing the present invention is shown schematically in FIG. 13. The panel comprises an active matrix OEL element 200 with analogue current program pixels, an integrated TFT scanning driver 210 with level shifter, a flexible TAB tape 220, and an external analogue driver LSI 230 with an integrated RAM/controller. Of course, this is only one example of the possible panel arrangements in which the present invention can be used.

The structure of the organic EL display device is not limited to the one described here. Other structures are also applicable

The improved pixel driver circuit of the present invention may be used in display devices incorporated in many types of equipment such as mobile displays e.g. mobile phones, laptop personal computers, DVD players, cameras, field equipment; portable displays such as desktop computers, CCTV or photo albums; or industrial displays such as control room equipment displays.

Several electric apparatuses using the above organic electroluminescent display device will now be described.

<1; Mobile Computer>

An example in which the display device according to one of the above embodiments is applied to a mobile personal computer will now be described.

FIG. 14 is an isometric view illustrating the configuration of this personal computer. In the drawing, the personal computer 1100 is provided with a body 1104 including a keyboard 1102 and a display unit 1106. The display unit 1106 is implemented using a display panel fabricated according to the present invention, as described above.

<2; Portable Phone>

Next, an example in which the display device is applied to a display section of a portable phone will be described. FIG. 15 is an isometric view illustrating the configuration of the portable phone. In the drawing, the portable phone 1200 is provided with a plurality of operation keys 1202, an earpiece 1204, a mouthpiece 1206, and a display panel 100, This display panel 100 is implemented using a display panel fabricated according to the present invention, as described above.

<3; Digital Still Camera>

Next, a digital still camera using an OEL display device as a finder will be described. FIG. 16 is an isometric view illustrating the configuration of the digital still camera and the connection to external devices in brief.

Typical cameras sensitize films based on optical images from objects, whereas the digital still camera 1300 generates imaging signals from the optical image of an object by photoelectric conversion using, for example, a charge coupled device (CCD). The digital still camera 1300 is provided with an OEL element 100 at the back face of a case 1302 to perform display based on the imaging signals from the CCD. Thus, the display panel 100 functions as a finder for displaying the object A photo acceptance unit 1304 including optical lenses and the CCD is provided at the front side (behind in the drawing) of the case 1302.

When a cameraman determines the object image displayed in the OEL element panel 100 and releases the shutter, the image signals from the CCD are transmitted and stored to memories in a circuit board 1308. In the digital still camera 1300, video signal output terminals 1312 and input/output terminals 1314 for data communication are provided on a side of the case 1302. As shown in the drawing a television monitor 1430 and a personal computer 1440 are connected to the video signal terminals 1312 and the input/output terminals 1314, respectively, if necessary. The imaging signals stored in the memories of the circuit board 1308 are output to the television monitor 1430 and the personal computer 1440, by a given operation.

Examples of electronic apparatuses, other than the personal computer shown in FIG. 14, the portable phone shown in FIG. 15, and the digital still camera shown in FIG. 16, include OEL element television sets, view-finder-type and monitoring-type video tape recorders, car navigation systems, pagers, electronic notebooks, portable calculators, word processors, workstations, TV telephones, point-of-sales system (POS) terminals, and devices provided with touch panels. Of course, the above OEL device can be applied to display sections of these electronic apparatuses.

The driver circuit of the present invention can be disposed not only in a pixel of a display unit but also in a driver disposed outside a display unit.

In the above, the driver circuit of the present invention has been described with reference to various display devices. The applications of the driver circuit of the present invention are much broader than just display devices and include, for example, its use with a magnetoresistive RAM, a capacitance sensor, a charge sensor, a DNA sensor, a night vision camera and many other devices.

FIG. 17 illustrates the application of the driver circuit of the present invention to a magnetic RAM. In FIG. 17 a magnetic head is indicated by the reference MH.

FIG. 18 illustrates an alternative application of the driver circuit of the present invention to a magnetic RAM. In FIG. 18 a magnetic head is indicated by the reference MH.

FIG. 19 illustrates the application of the driver circuit of the present invention to a magnetoresistive element. In FIG. 19 a magnetic head is indicated by the reference MH, and a magnetic resistor is indicated by the reference MR.

The aforegoing description has been given by way of example only and it will be appreciated by a person skilled in the art that modifications can be made without departing from the scope of the present invention.

1. A driver circuit for a current driven element, the circuit comprising an n-channel transistor and a complementary p-channel transistor connected so as to operatively control, in combination, the current supplied to the current driven element.

2. A driver circuit as claimed in claim 1, wherein the complementary n-channel and p-channel transistors comprise polysilicon thin film transistors.

3. A driver circuit as claimed in claim 2, wherein the complementary n-channel and p-channel transistors are spatially arranged in close proximity to each other for providing a complementary pair of n-channel and channel transistors having approximately equal threshold voltages.

4. A driver circuit as claimed in any one of claims 1 to 3 connected so as to establish when operative a voltage driver circuit comprising respective storage capacitors for the n-channel and p-channel transistors and respective switching means connected so as to establish when operative respective paths to the n-channel and p-channel transistors for respective data voltage pulses.

5. A driver circuit as claimed in any one of claims 1 to 3 comprising respective storage capacitors for storing a respective operating voltage of the n-channel and the p-channel transistors during a programming stage, a first switching means connected so as to establish when operative a first current path from a source of current data signals through the n-channel and p-channel transistors and the current driven element during the programming stage, and a second switching means connected to establish when operative a second current path through the n-channel and p-channel transistors and the current driven element during a reproduction stage.

6. A driver circuit as claimed in claim 5, wherein the first switching means and the source of current data signals are conncted so as to provide when operative a current source for the current driven element.

7. A driver circuit as claimed in claim 5, wherein the first switching means and the source of current data signals are connected so as to provide when operative a current sink for the current driven element.

8. A driver circuit as claimed in any one of claims 5 to 7, further comprising respective further switching means respectively connected to bias the n-channel transistor and the p-channel transistor to act as diodes during the programming stage.

9. A driver circuit as claimed in claim 8, wherein the respective further switching means comprise p-channel transistors.

10. A driver circuit as claimed in any one of claim 5 to 9, wherein the circuit is implemented with polysilicon thin film transistors.

11. A driver circuit as claimed in claim 4, wherein the circuit is implemented using polysilicon thin film transistors.

12. A driver circuit as claimed in any preceding claim, wherein the current driven element is an electroluminescent element.

13. A method of controlling the supply current to a current driven element comprising providing an n-channel transistor and a p-channel transistor connected so as to operatively control, in combination, the supply current to the current driven element.

14. A method as claimed in claim 13, comprising the further step of providing the n-channel transistor and the p-channel transistor as polysilicon thin film transistors.

15. A method as claimed in claim 14 comprising the further step of spatially arranging the n-channel and p-channel polysilicon thin film transistor in close proximity to each other.

16. A method as claimed in any one of claims 13 to 15 comprising providing respective storage capacitors for the n-channel and p-channel transistors and respective switching means connected so as to establish when operative respective paths to the n-channel an p-channel transistor for respective data voltage pulses thereby to establish, when operative, a voltage driver circuit for the current driven element.

17. A method as claimed in any one of claims 13 to 15 comprising providing a programming stage during which the n-channel and p-channel transistors are operated in a first mode and wherein a current path from a source of current data signals is established through the n-channel and the p-channel transistors and the current driven element and wherein a respective operating voltage of the n-channel transistor and the p-channel transistor is stored in respective storage capacitors, and a reproduction stage wherein a second mode and a second current path is established through the n-channel transistor and the p-channel transistor and the current driven element.

18. A method as claimed in claim 17, wherein the first mode comprises operating the n-channel and p-channel transistors as diodes.

19. A method of controlling the supply current to an electroluminescent display comprising the method as claimed in any one of claims 13 to 18 wherein the current driven element is an electroluminescent element.

20. An organic electroluminescent display device comprising a driver circuit as claimed in any one of claims 1 to 12.

21. An electronic apparatus incorporating an organic electroluminescent display device as claimed in claim 20.

22. A circuit comprising a current driven element and at least two active elements, the current driven element being disposed between the two active elements.

23. A circuit comprising a current driven element and at least two active elements, the two active elements being connected through the current driven element together.

24. The circuit according to claim 22 or claim 23, wherein the two active elements are transistors.

25. The circuit according to claim 24, wherein the two transistors are mutually different channel type transistors.

26. The circuit accrding to claim 22 or claim 23, wherein the current driven element is an organic electroluminescent element.

27. The circuit according to claim 24, wherein the gates of the two transistors are each connected to a respective capacitor.

28. An electro-optical device comprising the circuit according to claim 22.

29. An electronic apparatus incorporating an electro-optical device according to claim 28.

30. A method for driving a circuit comprising a current driven element, a first active element, and a second active element that is disposed at a side of the current driven element opposite to the first active element, controlling a current supplied to the current driven element by the first active element and the second active element.

31. The method according to claim 30, comprising the step of selecting the first active element to be a first transistor and selecting the second active element to be a second transistors.

32. The method according to claim 31, comprising a step of determining a gate voltage of at least one of the first transistor and the second transistor based on a predetermined current.

33. The method according to claim 32, comprising the step of causing the predetermined current to flow through a second current path different from a first current path that includes the current driven element.

34. The method according to claim 33, comprising the step of arranging the second current path to include at least one of the first transistor and the second transistor.
